(19) United States
(12) Patent Application Publication
(10) Pub. No.: US 2007/0174376 A1
(43) Pub. Date: Jul. 26, 2007

(54) Digital Filter Design System And Method

(76) Inventor: Brett David George, Studio City, CA (US)

Correspondence Address: ST. ONGE STEWARD JOHNSTON & REENS, LLC, 986 BEDFORD STREET, STAMFORD, CT, 06905-5619, US

(21) Appl. No.: 11/558,742

(22) Filed: Nov. 10, 2006

Related U.S. Application Data
(63) Continuation of application No. PCT/AU05/00677, filed on May 11, 2005.

(30) Foreign Application Priority Data
May 12, 2004 (AU) 2004902492

(51) Int. Cl. G06F 17/10

(52) U.S. Cl. 708/300

(57) ABSTRACT

A new method of designing digital filters for specific magnitude and phase requirements that minimises the filter's group-delay given arbitrary error tolerances is presented in this patent application. The method is extended to include optimising the original filter design based on the group-delay minimisation routine. A particular example that describes the linearisation of a filter channel under these conditions and given these constraints is shown. Embodiments may be applied to any digital filter design technique implemented in software, hardware, or a combination of both for applications such as equalisation or any area where filters are useful. The method disclosed is broadly applicable in the field of signal processing and may be used to advantage, for example in: channel equalisation, speaker and audio correction, echo-cancellation, control applications, digital audio broadcast, sonar and ultrasonics.

### CROSS-REFERENCE TO RELATED APPLICATIONS

The present application is a continuation of pending International patent application PCT/AU2005/000677 filed on May 11, 2005 which designates the United States and claims priority from Australian patent application 2004902492 filed on May 12, 2004, the content of which is incorporated herein by reference.

### FIELD OF THE INVENTION

The present invention relates to the field of digital signal processing and, in particular disclosed, a method and system for creating filter having predetermined group delays.

### BACKGROUND OF THE INVENTION

Digital filtering of discrete-time sampled signals is used extensively in commercial applications such as compact disc players, digital stereo systems, digital mixing boards, digital speaker crossover networks, and in many other audio and non-audio signal processing applications. In order to make digital filters practical for real-time applications, they must have sufficiently low computational complexity. Additionally, many applications require a linear-phase response in order to avoid frequency dependent temporal distortions. their computational simplicity, but introduce temporal distortions into signals because they do not have linear-phase response. FIR filters, on the other hand, can be designed to have linear-phase response and hence no temporal distortion, but are generally more costly to implement due to the large number of arithmetic operations performed per sample of input.

U.S. Pat. No. 5,548,543 to Wang entitled Computationally efficient linear-phase finite impulse response filter discloses how an IIR filter can be truncated to create a FIR filter of reduced complexity. The techniques disclosed form linear phase filters of reduced complexity, rather than FIR filters with a specific group-delay correction.

U.S. Pat. Nos. 5,511,129, 5,815,580, 5,627,899 disclose Compensating filters using a combination of minimum phase filters and linear phase filters to correct amplitude and phase errors of a loudspeaker and room system. However, the techniques described do not include using an allpass filter, or a modified allpass filter correcting a limited amount of phase with a controllable amount of overall group-delay.

U.S. Pat. No. 5,185,805 to Chiang entitled “Tuned deconvolution digital filter for elimination of loudspeaker output blurring” and U.S. Pat. No. 4,888,808 entitled “Digital equalizer apparatus enabling separate phase and amplitude characteristic modification” both describe methods of correcting the amplitude and phase of linear systems in a controllable manner using different techniques.

Standard allpass filter design routines such as R. Kumaresan, and A. Rao's, On Designing Stable Allpass Filters Using AR Modelling, IEEE Transactions on Signal Processing, Vol. 47, No.1, January 1999, pp. 229-231 or B. Yegnanarayana's, Design of Recursive Group-Delay Filters by Autoregressive Modelling, IEEE Transactions on Acoustics, Speech, and Signal Processing, Vol ASSP-30, No. 4, August 1982, pp 632-637, describe methods of creating allpass filters, but not with the intention of minimising the overall delay through the filter. In fact, their techniques introduce additional group-delay and have no discussion of minimising the group delay.

### SUMMARY OF THE INVENTION

It is an object of the present invention to provide an improved filter design.

In accordance with a first aspect of the present invention, there is provided a method of creating a final filter having a specified amplitude and phase response to within predetermined error tolerances, the method comprising the steps of: (a) designing a magnitude response filter which is also a minimum phase filter; (b) designing an allpass filter having predetermined phase properties; (c) combining the magnitude response filter and allpass filter to form the final filter.

The predetermined phase properties can include minimizing the group delay of the allpass filter. The allpass filter can be a Finite Impulse Response filter created from a windowed response of an Infinite Impulse Response filter. In some embodiments, the window of the windowed response can comprise either a rectangular window or a Hanning window. Preferably, the Finite Impulse Response filter has a phase response approximating the Infinite Impulse Response to a predetermined error measure. The shape or size of the window can be adjusted to meet the predetermined error measure. Also, the delay of the Finite Impulse Response filter can be adjusted to meet the predetermined error measure.

In accordance with a further aspect of the present invention, there is provided a method of designing a finite impulse response filter approximating an infinite impulse response allpass filter, the finite impulse response filter maximizing the group delay correction whilst simultaneously reducing the overall group delay and keeping the overall filter error within a predetermined tolerance, the method comprising the steps of: (a) from an initial maximum group delay correction value, determining a corresponding first allpass filter which minimizes its overall group delay; (b) if the resultant first allpass filter has a maximum group delay correction and the resultant finite impulse response filter is within the predetermined error tolerance, decreasing the amount of group delay; (c) otherwise, increasing the amount of group delay correction; (d) iterating through steps (a) to (c) until the method converges.

In accordance with a further aspect of the present invention, there is provided a method of approximating an Infinite Impulse Response filter with a Finite Impulse Response filter the method including the step of: (a) multiplying the Infinite Impulse Response filter with a windowing function to produce the finite impulse response function satisfying a predetermined error relationship to the Infinite Impulse Response function.

The method can further include the step of: (b) iteratively modifying the structure of the windowing function so that the Finite Impulse Response has a specified level of group-delay. The Finite Impulse Response filter can have a predetermined magnitude and group delay correction.

In accordance with a further aspect of the present invention, there is provided a method of linearising the phase of a linear time-invariant filter with arbitrary magnitude and phase response whilst controlling the amount of overall delay introduced by the resulting linearisation.

### BRIEF DESCRIPTION OF THE DRAWINGS

Preferred and other embodiments of the present invention will now be described with reference to the accompanying drawings in which:

FIG. 1 illustrates schematically the operation of a filter;

FIG. 2 illustrates schematically a digitial equalisation filter;

FIG. 3 illustrates the windowing processes used in the preferred embodiment;

FIG. 4 illustrates a flow chart of the process to minimise group delay given error constraints; and

FIG. 5 illustrates a flow chart of a process for filter optimisation.

### DETAILED DESCRIPTION OF THE INVENTION

### Description of the Preferred and Other Embodiments

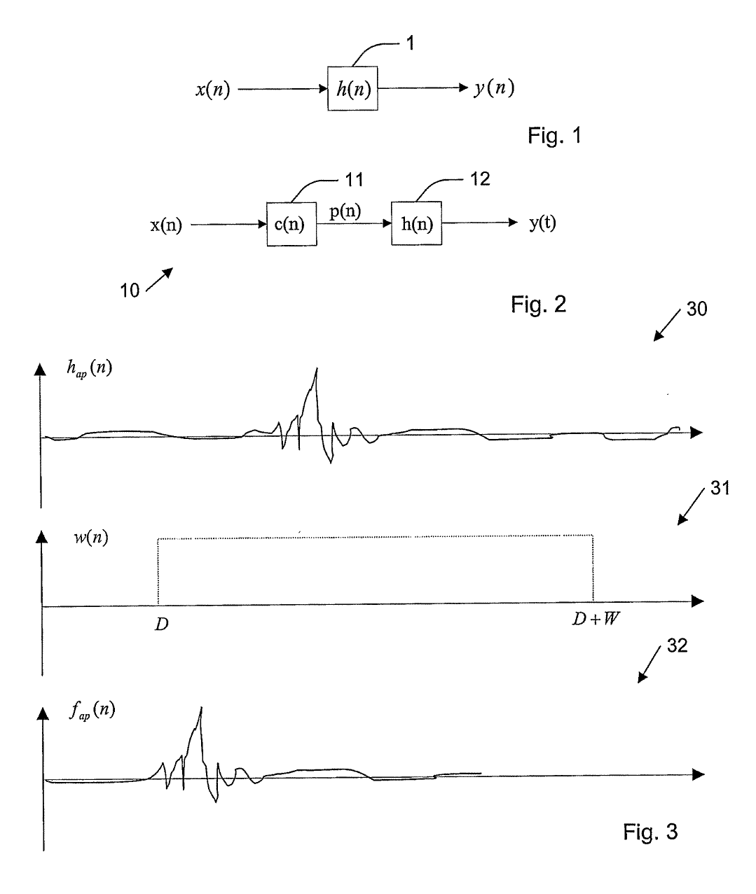

The purpose of a digital filter is to modify an input signal in a linear time-invariant fashion. Such a system is shown schematically in FIG. 1 wherein a discrete time (digital) input signal x(n), being convolved (or filtered) 1 by a filter described by h(n), to produce an output signal y(n).

Digital filtering can be represented in the time domain by equation (1). This relationship can also be shown as multiplication, if each signal is converted under the z-transform to form in Equation (2).

$$\begin{matrix}y ( n ) = {\sum }_{k = 0}^{n} x ( k ) h ( n - k ) , n \geq 0 & ( 1 ) \\ Y ( z ) = X ( z ) H ( z ) & ( 2 )\end{matrix}$$

Where the z-transform and Inverse z-transform are defined as (3) and (4).

$$\begin{matrix}X ( z ) = {\sum }_{n = - ∞}^{∞} x ( n ) {z}^{- n} & ( 3 ) \\ x ( n ) = \frac{1}{2 π j} {∮}_{C} X ( z ) {z}^{n - 1} ⅆ z & ( 4 )\end{matrix}$$

As shown in FIG. 1, if a signal x(n) 10, passes through a filter c(n) 11 to produce an output p(n), it is possible to post equalise h(n) 12 the resulting response in order to perform some sort of modification to compensate for the affects of the channel c(n). Assuming the system to be linear time-invariant, the equalisation filter h(n) can (in general) be anywhere in the signal chain. It could pre-filter the signal prior to entering the system c(n), or it could post-filter, depending on the type of application.

Furthermore, the system itself could be analogue, and the equalisation signal may be performed by sampling the analogue signal to convert it to the digital domain for filtering. It is also noted that a filter design technique can be used to design a digital filter, which can be converted to analogue using a number of commonly known techniques such as those described in chapter 8 of the standard textbook J. G. Proakis, D. G. Manolakis, Digital Signal Processing, Principles, Algorithms and Application, Prentice Hall 1996.

In the z-domain, the equation for the complete system in FIG. 2 is given by equation (5):
Y(z)=C(z)·H(z)·X(z) (5)

Where the channel and correction filter combine to give a total system response equivalent to S(z) defined in equation (6).
S(z)=C(z)·H(z) (6)

The preferred embodiment is directed to the process of equalisation to create a correction filter h(n) to compensate for particular characteristics of the system c(n). These will usually be subject to constraints on the resulting system S(z), or the filter itself h(n) or H(z). The choice of filter design depends on the application, and can vary depending of which aspect of the system needs to be equalised.

A common requirement is to minimise the error between a signal or group of signals x(n) passed through the system and their consequent response y(n). In a linear system, when only a single input/output combination is specified, this is equivalent to designing a filter that minimises the error between a desired filter response H′(z) and the actual response H(z).

Depending on the application, further constraints on the filter may appear. These can include a combination of:

The filter itself should be linear phase (the output response only differs from that of the input in that it has delay).

The convolution of the filter and channel should be linear phase (the output response to channel and the filter combined has the same phase as the input, except with a delay).

The filter should introduce as little additional group-delay in particular frequencies as possible.

The filter should fit into a particular processing topology, eg. Finite Impulse Response (FIR), or Infinite Impulse Response (IIR).

The filter should be optimised to meet particular design criteria.

Overview

The preferred embodiment describes a method for creating a filter that specifies amplitude and phase requirements, within given error tolerances. The method minimises the group delay of the resulting filter, subject to these tolerances.

The design process consists of two stages. The first is to design the magnitude Hₘᵢₙ(z), and the second Hₐₚ(z) is used to design the phase of the resulting filter. A minimum phase filter has the property that all of its roots are inside the unit circle. An allpass filter has the property that its magnitude response is equal to unity.

These two filters can be designed independently because an FIR filter can be factored into two polynomials that have their roots inside and outside the unit circle, B₁(z) and B₂(z) respectively as shown in equation (7). It is known that H(z) is the product of a minimum phase filter and an allpass filter (8).

$$\begin{matrix}H ( z ) = {B}_{1} ( z ) {B}_{2} ( z ) & ( 7 ) \\ H ( z ) = {H}_{min} ( z ) {H}_{ap} ( z ) & ( 8 ) \\ where , {H}_{min} ( z ) = {B}_{1} ( z ) {B}_{2} ( {z}^{- 1} ) & ( 9 ) \\ and {H}_{ap} ( z ) = \frac{{B}_{2} ( z )}{{B}_{2} ( {z}^{- 1} )} & ( 10 )\end{matrix}$$

The process can then proceed by two independent tasks, the first being to design a minimum phase filter, and the second to design an allpass filter. If we evaluate the response around the unit circle as in equation (11) we are able to determine its magnitude equation (12) and phase equation (13) response, in terms of the minimum and allpass components.
H(z)|_{z=e}_{^{jw}}=|H(w)|e^{jΘ(w)} (11)
|H(w)|=|Hₘᵢₙ(w)|·|Hₐₚ(w)| (12)
Θ_{H}(w)=Θ_{H}_{ₘᵢₙ}(w)+Θ_{H}_{ₐₚ}(w) (13)

The group delay can be easily computed from the phase response as in equation (14), giving the group delay of the entire system equal to equation (15) (Oppenheim Discrete Time Signal Processing, p. 246). Since the allpass filter Hₐₚ(w) does not affect the magnitude response of H(w) and the group delay of the allpass filter is always positive, it follows that H(w) must have the smallest possible group delay of any filter for that given magnitude. Therefore, if we wish to minimise the group-delay of H(w), the problem is reduced to minimising the group delay of the allpass filter Hₐₚ(w).

$$\begin{matrix}grd [ H ( w ) ] = - \frac{ⅆ {Θ}_{H} ( w )}{ⅆ ω} & ( 14 ) \\ grd [ H ( ω ) ] = grd [ {H}_{min} ( ω ) ] + grd ⌊ {H}_{ap} ( ω ) ⌋ & ( 15 )\end{matrix}$$

To obtain the absolute minimum of group delay through the system, the filter could be entirely minimum phase, but by definition a minimum phase filter is completely determined by its magnitude response, and so it is impossible to design a minimum phase filter to both magnitude and phase constraints. This is why an allpass filter is required to design a filter of both arbitrary magnitude and phase specifications. In order to achieve group delay correction in addition to the phase correction provided by the minimum phase filter, the allpass filter will add additional group-delay. The preferred embodiment provides a means to control how much additional delay will be introduced by the allpass filter.

The Initial Filter Design

For the desired minimum phase filter H′ₘₚ(w) one can obtain an actual minimum phase filter that is used in the calculations Hₘₚ(w). The minimum phase filter is usually specified in terms of its magnitude response |H′ₘₚ(w)|, and could use, for example, the technique suggested by M. N. Chit and J. S. Mason Chit, M. N; Mason, J. S.; Design of minimum phase FIR filters, Circuits, Devices and Systems, IEEE Proceedings G, Vol. 135, Issue 6, December 1998, pp 258-264. The desired allpass filter H′ₐₚ(w) is specified in terms of its phase Θ_{H}_{ₐₚ}(w) or group delay grp[H′ₐₚ(w)], which upon using the techniques suggested by A. Rao, On Designing Stable Allpass Filters Using AR Modelling, IEEE Transactions on Signal Processing, Vol. 47, No. 1, January 1999, pp. 229-231, or B. Yegnanarayana, Design of Recursive Group-Delay Filters by Autoregressive Modelling, IEEE Transactions on Acoustics, Speech, and Signal Processing, Vol ASSP-30, No. 4, August 1982, pp 632-637 an actual allpass filter Hₐₚ(w) can be derived.

The process of designing the filters may introduce additional errors between the desired response and the actual designed filter. These errors can be taken into account during the process of the preferred embodiment, but their minimisation is not critical. It is assumed that the designed filters meet the requirements of the users error tolerances outlined below.

Modification to the Allpass Filter to Create an FIR Filter

Previously, it was noted that in order to minimise the group-delay for an arbitrary filter, it is necessary to only minimise the group delay of the allpass filter. To do this, a technique is used that windows the response of the Infinite Impulse Response (IIR) filter to create a Finite Impulse Response (FIR) filter of reduced group delay.

An IIR allpass filter is given by definition in equation (16) or in terms of its numerator and denominator in equation (17).

$$\begin{matrix}{H}_{ap} ( z ) = \frac{{\sum }_{k = 0}^{N} a ( k ) {z}^{k - N}}{{\sum }_{k = 0}^{N} a ( k ) {z}^{- k}} , a ( 0 ) = 1 & ( 16 ) \\ {H}_{ap} ( ω ) = \frac{N ( ω )}{D ( ω )} & ( 17 )\end{matrix}$$

When used in a complete system as in equation (18), a given input sequence x(n), produces an output as given by equation (19).

$$\begin{matrix}Y ( z ) = {H}_{ap} ( z ) \cdot X ( z ) & ( 18 ) \\ y ( n ) = - {\sum }_{k = 1}^{N} a ( k ) y ( n - k ) + {\sum }_{k = 0}^{N} a ( N - k ) x ( n - k ) & ( 19 )\end{matrix}$$

It is because each output depends on the previous output that the filter is said to be of infinite duration. Alternatively, the sequence could be written in the form of an FIR filter of infinite length as in equation (20), where h(n) is determined by the inverse-z transform of equation (16).

$$y ( n ) = {\sum }_{k = 0}^{∞} {h}_{ap} ( k ) x ( n - k ) \qquad ( 20 )$$

In equation (17), if θ₂(w) denotes the phase of the denominator D(w) it can be shown (see B. Yegnanarayana, Design of Recursive Group-Delay Filters by Autoregressive Modelling, IEEE Transactions on Acoustics, Speech, and Signal Processing, Vol ASSP-30, No. 4, August 1982, pp 632-637) that the overall phase response θ(w) of the allpass filter Hₐₚ(w) is equal to −Nw−2θ₂(w) where N is the length of the allpass filter. It follows then that for an allpass filter designed to a specific phase requirement θ₂(w) or group-delay requirement

$$- \frac{ⅆ {θ}_{2} ( ω )}{ⅆ ω} ,$$

the allpass filter will have additional group delay of N samples at the frequencies where the desired group delay is equal to zero.

This illustrates one of the key problems with using standard methods of allpass filter designs, in that the techniques add group delay in addition to the group delay that they correct. In an attempt to modify the designed allpass filter, the method of windowing the designed filter with a window of W samples is provided to create a filter of finite length. The window can be defined as in equation (21) and some example windows could include the rectangular window (equation (22)) or the Hanning window (equation (23)).

$$\begin{matrix}w ( n ) = \{ \begin{matrix}{w}_{n} , & 0 \leq n < W \\ 0 , & n \geq W\end{matrix} & ( 21 ) \\ w ( n ) = \{ \begin{matrix}1 , & 0 \leq n < W \\ 0 , & n \geq W\end{matrix} & ( 22 ) \\ w ( n ) = \{ \begin{matrix}\frac{1}{2} ( 1 - cos ( \frac{2 π n}{W - 1} ) ) , & 0 \leq n < W \\ 0 , & n \geq W\end{matrix} & ( 23 )\end{matrix}$$

Multiplying the infinite length filter h(n) with this window, produces a FIR filter of W samples. A further generalisation of the modified filter provides a delay parameter D, creating a new filter fₐₚ(n) defined by equation (24) and the complete system by equation (25).

$$\begin{matrix}{f}_{ap} ( n ) = {h}_{ap} ( n + D ) w ( n ) , 0 \leq n < W & ( 24 ) \\ y ( n ) = {\sum }_{k = 0}^{W} {f}_{ap} ( k ) x ( n - k ) & ( 25 )\end{matrix}$$

FIG. 3 illustrates an example of the original filter hₐₚ(n) 30, the windowing function w(n) 31 and the resulting windowed function fₐₚ(n) 32.

The Error Resulting From the Windowed IIR Filter

The result above shows how to use the parameters w(n), W and D to modify an infinite length filter to create a finite length filter. The effect of this modification to the signal are not without consequences however, because there may have been significant information in the infinite response that is no longer present in the new filter. It is useful then to define a measure ψₙ and ψ_{w} of signal degradation resulting from the creation of the filter fₐₚ(n) from hₐₚ(n) in equation (24). Equation (26) define this in general in the time-domain and equation (27) in the discrete frequency-domain. The choice of the function Pₙ or P_{w} is arbitrary and can be defined by a user given their particular requirements, but it is usually determined by some error measure between the desired allpass filter h′ₐₚ(n) or H′ₐₚ(w) and the result of the windowed filter fₐₚ(n) or Fₐₚ(w). The resulting error of the minimum phase filter design can also be taken into account at this stage, but the method of ensuring its minimisation is more related to the specific design technique used.
ψₙ=Pₙ(h′ₐₚ(n), fₐₚ(n)) (26)
ψ_{w}=P_{w}(H′ₐₚ(w), F′ₐₚ(w)) (27)

For each time-sample n or frequency-sample w of degradation ψₙ or ψ_{w}, the filter designer can specify a corresponding error tolerance εₙ or ε_{w}, a maximum (or minimum) error that must be adhered to in order to achieve a satisfactory filter. These are specific values for time and frequency, and could be selected to be any value given the requirements of the final filter.

Minimising the Group Delay to Meet the Error Constraints

After defining the error measure functions Pₙ and/or P_{w} with a corresponding εₙ and/or ε_{w}, the method of minimising the group delay to meet these constraints is then a matter of choosing the window w(n), its length W and the delay value D.

In general, optimising these constraints is a non-linear problem of multiple variables. Such a problem can be solved using Non-Linear optimisation techniques such as simulated annealing or, for example, using a genetic algorithm (S. C. Ng, S. H. Leung, C. Y. Chung, A. Luk and W. H. Lau, The Genetic Search Approach, IEEE Signal Processing Magazine, November 1996, pp 38-46)—a technique well suited for solving such a difficult problem possibly having multiple local minima.

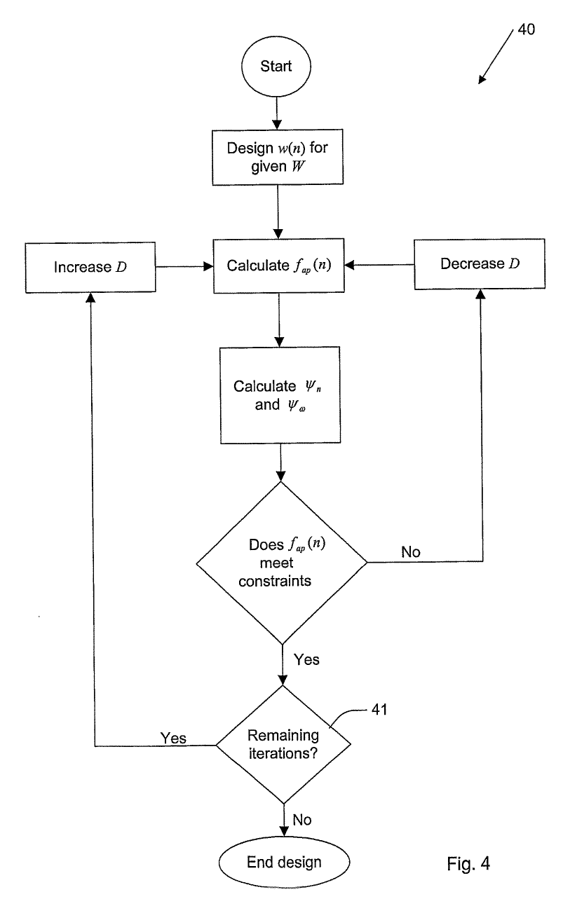

Alternatively, the problem can be reduced to one of a single variable by fixing all the variables except one. In our experiments we have found it useful to use a fixed window (such as a rectangular, Hanning or Tukey window) and length, whilst maximising the delay parameter D such that ψₙ<εₙ and ψ_{w}<ε_{w}. This problem is considerably simpler, and could be solved, for example, using a gradient method of steepest descent to find a global minima. FIG. 4 illustrates a flow chart 40 of a simple algorithm for obtaining such a solution. The solution is reached when the remaining iterations stage 41 fails when it would not be possible to maximise D (minimise the group delay) of the allpass filter and still have the error within tolerances.

The resulting final group delay of the allpass filter is defined in equation (28), and is clearly a function of the window parameters w(n), W and D; as well as the original filter Hₐₚ(w).
C=max(grd└Fₐₚ(w)┘) (28)
1.1 Brief Summary

The method previously described is important because it defines a way of reducing the group delay of existing allpass filter designs subject to the arbitrary error constraints previously defined. A simple method of using this invention would be to design a desired digital filter once, and then use the method described above to minimise the delay subject to the user's own constraints.

Alternative Optimisation Routine

If we find that our error functions are decreasing as we increase our delay value D, and our purpose is to minimise the error constraints (26) and (27) subject to a specific maximum delay requirement C_{MAX}, the method above can be simplified by forcing the delay of the filter to be equal to this level of group delay D=C_{MAX}. The procedure then reduces to that of solving for the remaining variables w(n) and W. This technique can be used as an alternative to the one described above, if the criteria for optimisation is different.

Additional Optimisation

The complete method described above provides a method of reducing a single filter's group delay, but because the amount of group delay that was corrected with that allpass filter was already decided at the beginning of the design, there remains the possibility that a better filter could have been designed to provide more group delay correction. Conversely, if the filter design failed to meet the error tolerances or failed to meet a minimum value of group delay C_{MAX} such that the result of (28), produced C>C_{MAX}, there is the opportunity of modifying the original desired filter Hₐₚ(w) to meet these constraints.

Maximising Group-delay Correction and Minimising Overall Group-delay Whilst Keeping the Overall Error Within the Required Tolerances

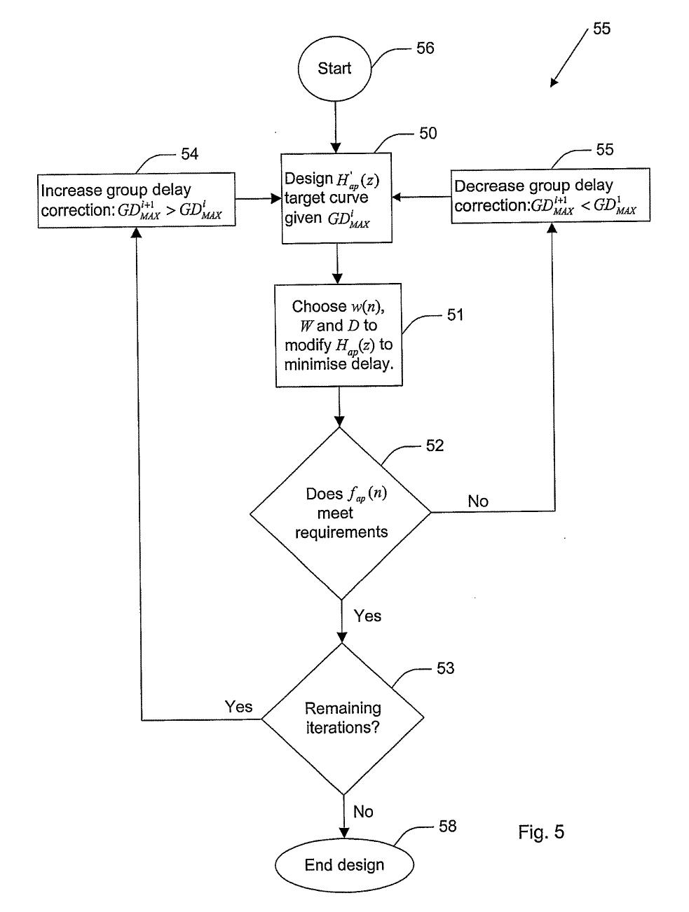

A further outer optimisation technique can be provided that uses the technique referred to above as one of its core features. The design technique is shown in the flowchart FIG. 5, while the Table below provides a more detailed description of each function of FIG. 5. The routine 55 begins 56 with a known maximum value of group-delay for the final allpass filter C_{MAX}. The result of the entire algorithm must produce a filter to this requirement that is still within the error constraints. If it fails to do that, then an impulse response is designed which provides no phase correction or delay. The filter design is checked after each iteration of the core optimisation routine 51 described above. If it is met 52, the desired filter H′ₐₚ(z) is redesigned to include further group-delay correction 55. If it wasn't, less correction is attempted 54 in the desired filter and the process begins again. The optimisation process is complete when it is not possible to re-design a H′ₐₚ(z) to provide more correction of group-delay and still meet the requirements of the minimum group-delay specified when the routine began.

| | |
|---|---|
| 50 | At the i'th iteration, the design of an allpass filter Hₐₚ^{i′}(ω) is |
| | begun with an attempt at correcting a maximum group delay value |
| | of GD_{MAX}ⁱ such that GD_{MAX}ⁱ ≧ max(grd[Hₐₚ^{i′}(ω)]). |
| 51 | This section uses the optimisation routine described above to |
| | minimise the group-delay or minimise the error of the Hₐₚⁱ(z) filter. |
| 52 | After calculating the filter fₐₚⁱ(n), the results of 51 are checked |
| | to see whether the filter could meet the group delay requirement |
| | C_{MAX} ≧ max(grd[Fₐₚⁱ(ω)]) and still keep the error within the |
| | required tolerance levels defined in section 0. |
| 53 | When it would not be possible to increase the group delay correction |
| | in the target curve hₐₚ^{i′}(n) to improve the results, or C_{MAX}ⁱ⁺¹ |
| | will be zero (no group delay correction is possible) the optimisation |
| | process is complete. |
| 54 | The value of GD_{MAX}ⁱ⁺¹ is increased to provide further group-delay |
| | correction for the next iteration. |
| 55 | The value of GD_{MAX}ⁱ⁺¹ is decreased to provide less group-delay |
| | correction for the next iteration. |

An Example Group Delay Correction Routine

The forgoing describes a method to minimise the group delay of an allpass filter subject to error constraints. The designed filter can be modified to maximise the group delay correction but still keep the group delay to a specified minimum and the error of the overall process within the required tolerances.

Described below is a method which uses these techniques to design a filter that corrects a channels phase response such that it is linear over a specific frequency region.

Designing a Filter to Linearise the Channel Phase P As discussed above, the filter design procedure can be separated into two independent tasks. The first being to design a minimum phase filter, and the second to design an allpass filter.

For a given filter channel C(w), we can combine the filter and the channel into the complete system as in equation (6). Further separating the filter into its allpass and minimum phase components, we have equation (29), with a system group delay given by equation (30).
S(w)=C(w)Hₘᵢₙ(w)Hₐₚ(w) (29)
grd[S(w)]=grd[C(w)]+grd[Hₘᵢₙ(w)]+grd└Hₐₚ(w)┘ (30)

To linearise the phase of the system S(z), the group delay should be a constant value Dₛ, specifying the group delay of the allpass filter to be given by equation (31).
grd└Hₐₚ(w)┘=grd [C(w)]+grd[Hₘᵢₙ(w)]−Dₛ (31)

Since the group delay of an allpass filter is always positive, it is essential to choose the delay of the system to satisfy the constraint in (32).
GD_{MAX}≧max(grd[C(w)]+grd[Hₘᵢₙ(w)]) (32)

The value of GD_{MAX} in (32) may not be appropriate in designs for a number of reasons. The delay may be more than allowable for that particular design. It may require a filter that is too long and requires too much processing for the particular application. It may be that only a specific portion of the system is important for the particular design and it is a waste of resources to achieve this requirement. A well-known technique in the literature (S. K. Kitra, J. F. Kaiser, Handbook of Digital Signal Processing, Chapter 5, Prentice Hall 1996, p 322) is to only linearise a specific portion of the frequency response. The desired system response in equation (33) can then specify the delay over a particular frequency range. Generalising further, it is also possible to linearise the response over more than one set of frequencies. From equation (33), the desired allpass filter Hₐₚ(w) is specified as in equation (34). Such a filter Hₐₚ(w) can then be used in the optimisation routine described previously.

$$\begin{matrix}grd [ S ( ω ) ] = \{ \begin{matrix}{GD}_{MAX} , & if {ω}_{1} \leq ω \leq {ω}_{2} \\ grd [ C ( ω ) ] + grd [ {H}_{min} ( ω ) ] , & if ω < {ω}_{1} , ω > {ω}_{2}\end{matrix} & ( 33 ) \\ \begin{matrix}grd [ {H}_{ap} ( ω ) ] = \\ \{ \begin{matrix}{GD}_{MAX} - grd [ C ( ω ) ] - grd [ {H}_{min} ( ω ) ] , & if {ω}_{1} \leq ω \leq {ω}_{2} \\ 0 , & if ω < {ω}_{1} , ω > {ω}_{2}\end{matrix}\end{matrix} & ( 34 )\end{matrix}$$

### Additional Embodiments

It is not essential that the design technique split the filter design into a minimum phase and allpass design criterions designed independently. It is equally applicable that the optimisation routines defined previously work for a filter whose design is mixed phase.

Implementation

The preferred embodiment can be implemented by suitable programming of a computer system. Alternatively, the preferred embodiment could be implemented in a hardware encoded system such as a VHDL design (although this is likely to form a non-optimal and more costly design). Further, the end filters created can be readily incorporated into audio signal processing devices for the processing of audio signals.

The forgoing describes preferred forms of the invention. Modifications, obvious to those skilled in the art can be made thereto without departing from the scope of the invention.

What is claimed is:

1. A method of creating a final filter having a specified amplitude and phase response to within predetermined error tolerances, the method comprising the steps of:
(a) designing a magnitude response filter which is also a minimum phase filter;
(b) designing an allpass filter having predetermined phase properties;
(c) combining the magnitude response filter and allpass filter to form said final filter.

2. A method as claimed in claim 1 wherein said predetermined phase properties include minimizing the group delay of the allpass filter.

3. A method as claimed in claim 2 wherein said allpass filter is a Finite Impulse Response filter created from a windowed response of an Infinite Impulse Response filter.

4. A method as claimed in claim 3 wherein the window of the windowed response comprises either a rectangular window or a Hanning window.

5. A method as claimed in claim 3 wherein said Finite Impulse Response filter has a magnitude and phase response approximating the Infinite Impulse Response to a predetermined error measure.

6. A method as claimed in claim 5 wherein the shape or size of said window is adjusted to meet said predetermined error measure.

7. A method as claimed in claim 5 wherein the delay of said Finite Impulse Response filter is adjusted to meet said predetermined error measure.

8. A method of designing a finite impulse response filter approximating an infinite impulse response allpass filter, the finite impulse response filter maximizing the group delay correction whilst simultaneously reducing the overall group delay and keeping the overall filter error within a predetermined tolerance, the method comprising the steps of:
(a) from an initial maximum group delay correction value, determining a corresponding first allpass filter which minimizes its overall group delay;
(b) if the resultant first allpass filter has a maximum group delay correction and the resultant finite impulse response filter is within said predetermined error tolerance, decreasing the amount of group delay;
(c) otherwise, increasing the amount of group delay correction;
(d) iterating through steps (a) to (c) until said method converges.

9. A method of designing a finite impulse response filter approximating an infinite impulse response allpass filter, the finite impulse response filter substantially minimising the filters error, whilst providing a specific level of group delay correction.

10. A method of approximating an Infinite Impulse Response filter with a Finite Impulse Response filter the method including the step of:
(a) multiplying said Infinite Impulse Response filter with a windowing function to produce said finite impulse response function satisfying a predetermined error relationship to said Infinite Impulse Response function

11. A method as claimed in claim 10 further comprising the step of:
(b) iteratively modifying the structure of the windowing function so that said Finite Impulse Response has a specified level of group-delay.

12. A method as claimed in claim 11 wherein said Finite Impulse Response filter has a predetermined magnitude and group delay correction.

13. A method of linearising the phase of a of a linear time-invariant filter with arbitrary magnitude and phase response whilst controlling the amount of overall delay introduced by the resulting linearisation.

14. A method of designing a finite impulse response filter approximating an infinite impulse response allpass filter, the finite impulse response filter maximizing the group delay correction whilst keeping an overall filter error within a predetermined tolerance.
